(19) United States
(12) Patent Application Publication
(10) Pub. No.: US 2026/0194667 A1
(43) Pub. Date: Jul. 9, 2026

(54) SIGNAL DETECTION MODULE

(71) Applicant: Brightonix Imaging Inc., Seoul (KR)

(72) Inventors: Guen Bae KO, Seoul (KR); Dongjin KWAK, Gwangmyeong-si (KR); Jae Sung LEE, Seoul (KR)

(73) Assignee: Brightonix Imaging Inc., Seoul (KR)

(21) Appl. No.: 19/438,129

(22) Filed: Dec. 31, 2025

(30) Foreign Application Priority Data
Jan. 9, 2025 (KR) 10-2025-0003312
Aug. 19, 2025 (KR) 10-2025-0115035

(51) Int. Cl. G01T 1/202; G01T 1/20

(52) U.S. Cl. CPC G01T 1/202; G01T 1/2006

(57) ABSTRACT

The present invention relates to a signal detection module, including scintillation crystals configured to generate and output optical signals in response to incident radiation, each scintillation crystal having at least one unpolished first surface, wherein a plurality of the scintillation crystals are arranged in a plurality of rows and a plurality of columns, and scintillation crystals facing each other are arranged such that the first surfaces thereof are in contact with each other, thereby enabling improvement in timing resolution and signal detection efficiency.

### STATEMENT REGARDING FEDERALLY SPONSORED RESEARCH OR DEVELOPMENT

A research and work product related to the present invention was supported by the Korea Medical Device Development Fund grant funded by the Korea government (the Ministry of Science and ICT, the Ministry of Trade, Industry and Energy, the Ministry of Health & Welfare, the Ministry of Food and Drug Safety) (Project Number: 1711137868, RS-2020-KD000006).

### CROSS-REFERENCE TO RELATED APPLICATION(S) AND CLAIM OF PRIORITY

This application is based on and claims priority under 35 U.S.C. § 119 to Korean Patent Application No. 10-2025-0003312, filed on Jan. 9, 2025, and Korean Patent Application No. 10-2025-0115035, filed on Aug. 19, 2025, in the Korean Intellectual Property Office, the disclosure of which is herein incorporated by reference in its entirety.

### TECHNICAL FIELD

The present invention relates to a signal detection module, and more particularly, to a signal detection module capable of improving timing resolution.

### BACKGROUND ART

Demand for high-performance PET (positron emission tomography) detectors has increased due to the growing interest in next-generation PET systems, such as brain-dedicated PET and long axial field-of-view (FOV) PET systems. In PET detectors of such systems, time-of-flight (TOF) has become an essential technology because it improves image signal-to-noise ratio, enhances effective sensitivity, and reduces correction errors. Furthermore, these systems tend to exhibit more parallax errors compared to conventional PET systems, increasing the need for depth-of-interaction (DOI) information.

As a result, extensive research and development have focused on high-performance PET detectors that integrate both TOF and DOI functionalities.

Efforts to develop TOF/DOI detectors can be categorized into several groups. One approach, referred to as the “relative offset method,” involves stacking scintillation crystals in a half-pitch offset structure. This method facilitates clear DOI discrimination in the crystal map and supports the use of multiplexed readout. However, when attempting to achieve multiple DOI layers, manufacturing complexity increases and light transmission decreases at crystal interfaces, causing optical loss and adversely affecting TOF performance.

Another approach utilizes differences in light dispersion depending on DOI. This method offers the advantage of distinguishing DOI without increasing the number of photosensors. Typically, differences in optical dispersion are achieved by modifying reflector structures, but DOI discrimination can also be implemented by adding optical paths within multi-layered scintillation crystal units. However, this requires the ability to measure the spatial distribution of light spreading at the photosensor, resulting in increased system complexity and higher data acquisition requirements.
(Patent Document) Korean Registered Patent No. KR10-1092648

### DISCLOSURE

### Technical Problem

The present invention provides a signal detection module capable of improving timing resolution.

### Technical Solution

According to an embodiment of the present invention, a signal detection module includes scintillation crystals configured to generate and output optical signals in response to incident radiation, each scintillation crystal having at least one unpolished first surface, wherein the scintillation crystals are arranged in a plurality of rows and a plurality of columns, and scintillation crystals facing each other are arranged such that the first surfaces thereof are in contact with each other.

Each scintillation crystal may further include a polished second surface connected to the first surface, wherein scintillation crystals arranged with the first surfaces in contact with each other constitute a scintillation crystal unit, and wherein the second surface is arranged to surround at least a portion of the scintillation crystal unit.

The scintillation crystals constituting the scintillation crystal unit may be arranged to form two or more rows and two or more columns.

A plurality of scintillation crystal units may be arranged in rows and columns, and scintillation crystal units facing each other may be arranged such that the second surfaces thereof are in contact with each other.

Each scintillation crystal may have a prismatic shape including a top surface, a bottom surface, and a plurality of side surfaces, wherein at least one of the plurality of side surfaces includes the first surface.

### Advantageous Effects

According to an embodiment of the present invention, the timing resolution is optimized by configuring a signal detection device using scintillation crystals having both polished surfaces and unpolished surfaces. Such a signal detection device can implement energy resolution and depth-of-interaction (DOI) performance comparable to those of conventional signal detection devices using scintillation crystals in which all surfaces are polished or scintillation crystals in which all surfaces are unpolished.

In particular, the signal detection device according to the embodiment of the present invention exhibits more uniform DOI performance and collects a greater number of optical photons compared to a conventional signal detection device using scintillation crystals in which all surfaces are unpolished. Accordingly, superior energy measurement performance and timing resolution can be obtained, and thus the signal detection device can be applied to the development of a time-of-flight/depth-of-interaction (TOF/DOI) positron emission tomography (PET) system with excellent image quality.

In addition, by using the surface finishing treatment of scintillation crystals according to the embodiment of the present invention, it is possible to help improve the timing resolution of detectors such as a bismuth germanate (BGO) detection device that detects Cherenkov light.

### DESCRIPTION OF DRAWINGS

FIG. 1 illustrates a schematic configuration of a signal detection device according to an embodiment of the present invention.

FIG. 2 illustrates a perspective view and a top view of a scintillation crystal assembly constituting the signal detection device according to an embodiment of the present invention.

FIG. 3 illustrates circuit diagrams showing various embodiments of a position-information provider unit constituting the signal detection device according to an embodiment of the present invention.

FIG. 4 illustrates diagrams for explaining experimental conditions using the signal detection device according to an embodiment of the present invention.

FIG. 5 illustrates flood maps obtained from experiments performed using the signal detection device according to an embodiment of the present invention.

FIG. 6 illustrates depth-of-interaction (DOI) index histograms obtained from experiments performed using the signal detection device according to an embodiment of the present invention.

FIG. 7 illustrates depth-of-interaction (DOI) resolution maps obtained from experiments performed using the signal detection device according to an embodiment of the present invention.

FIG. 8 illustrates graphs showing changes in detection performance according to a bias voltage and a surface finishing method of a scintillation crystal.

FIG. 9 illustrates graphs showing photopeak positions according to DOI layers and a bias voltage.

FIG. 10 illustrates graphs showing energy resolution according to DOI layers and a bias voltage.

FIG. 11 illustrates graphs showing timing resolution according to DOI layers and a bias voltage.

### MODES OF THE INVENTION

The embodiments of the present invention will now be described in detail with reference to the accompanying drawings. However, the present invention is not limited to the embodiments set forth below and may be implemented in various different forms. These embodiments are provided so that the disclosure may be complete and to fully convey the scope of the invention to those skilled in the art. Throughout the drawings, like reference numerals refer to like elements.

The shapes, dimensions, ratios, angles, and numbers illustrated in the drawings for describing the embodiments are merely illustrative and do not limit the scope of the invention. In addition, to avoid obscuring the essence of the invention, detailed descriptions of known technologies that may unnecessarily complicate the present disclosure may be omitted. The terms “include,” “have,” and “comprise,” as used in this specification, do not exclude the presence of additional components unless explicitly stated otherwise. A singular form includes the plural unless otherwise stated. Any component described herein shall be interpreted as including allowable tolerances unless expressly stated otherwise.

Descriptions such as “on,” “above,” “below,” or “next to” indicating positional relationships do not require direct contact unless the terms “directly” or “immediately” are used, and one or more intervening elements may exist.

A layer or element described as being “on” another element includes both cases: directly on the element and interposed with one or more additional layers or elements. Throughout the specification, identical reference numerals denote identical components. Although the terms “first,” “second,” and similar expressions are used to describe various elements, such terms do not limit the corresponding elements. These terms simply distinguish one element from another. Therefore, a first element described below may also be interpreted as a second element within the technical spirit of the invention.

The dimensions and thicknesses of elements shown in the drawings are illustrated for convenience of explanation and do not necessarily limit the actual dimensions or thicknesses of the elements. Features of various embodiments may be combined, interlocked, or implemented independently or jointly, and the embodiments may be modified in numerous ways that would be technically apparent to those skilled in the art.

In the present invention, the signal detection module may be understood as having the same or similar meaning as a signal detection device, and may be considered as a concept included within a signal detection device.

Before describing the present invention, a dual-end readout method to which the present invention is applied will be described.

The dual-end readout method attaches photosensors to both an upper surface and a lower surface of a scintillation crystal, and calculates a depth-of-interaction (DOI) by measuring a difference in an amount of light reaching each photosensor according to a depth of gamma-ray interaction. Although this method has a disadvantage in that costs increase because photosensors are installed on both sides of the scintillation crystal, it has an advantage in terms of improving timing resolution because initial direct photons that are not reflected at a surface of the scintillation crystal can be detected from both ends of the scintillation crystal. In addition, this method is advantageous for multiplexing channels of photosensors that detect light.

The dual-end readout method has been utilized and proposed by various research groups, and its usefulness has significantly increased with the introduction of silicon photomultipliers (SiPMs). Unlike bulky photomultiplier tubes (PMTs), SiPMs are relatively thin, and thus even when attached to a front surface of a scintillation crystal (a surface on which gamma rays are incident), they do not occupy much space, thereby reducing gamma-ray loss due to attenuation. In the dual-end readout method, the DOI is determined by a difference in an amount of light reaching photosensors installed on upper and lower surfaces of the scintillation crystal, and therefore increasing this difference improves DOI resolution. Such a difference in light intensity is mainly caused by a difference in optical path lengths of light reaching opposite ends of the scintillation crystal according to the DOI. As the optical path length of light increases, a number of interactions with side surfaces of the scintillation crystal increases, thereby increasing a possibility of photon loss. For this reason, in order to increase photon loss related to the optical path length, side surfaces of the scintillation crystal applied to a dual-end signal detection device are processed as unpolished surfaces rather than polished surfaces having high reflectivity. Accordingly, surface treatment of the scintillation crystal can act as an important factor in determining performance of this type of detector.

Therefore, the present invention proposes a dual-end signal detection device using scintillation crystals having both polished surfaces and unpolished surfaces. When applied to a brain-dedicated PET system, such a dual-end signal detection device may include a scintillation crystal assembly in which scintillation crystals having a size of 2 mm are arranged in an 8×8 array. In addition, in order to multiplex SiPM signals, strip-shaped or band-shaped detector units are combined with a one-dimensional charge-division method in the scintillation crystal assembly, so that scintillation crystals can be identified and DOI can be calculated using only four signal lines, similarly to a single-end signal detection device.

The signal detection device according to the present invention requires only four channels for position signals. Multiplexing a large number of SiPM signals into four channels is a common practice in PET detection devices, which means that many existing data acquisition (DAQ) systems are already optimized for this configuration. Accordingly, the signal detection device according to the present invention can collect position signals without modifying an existing DAQ system.

Hereinafter, a signal detection device and method according to embodiments of the present invention will be described.

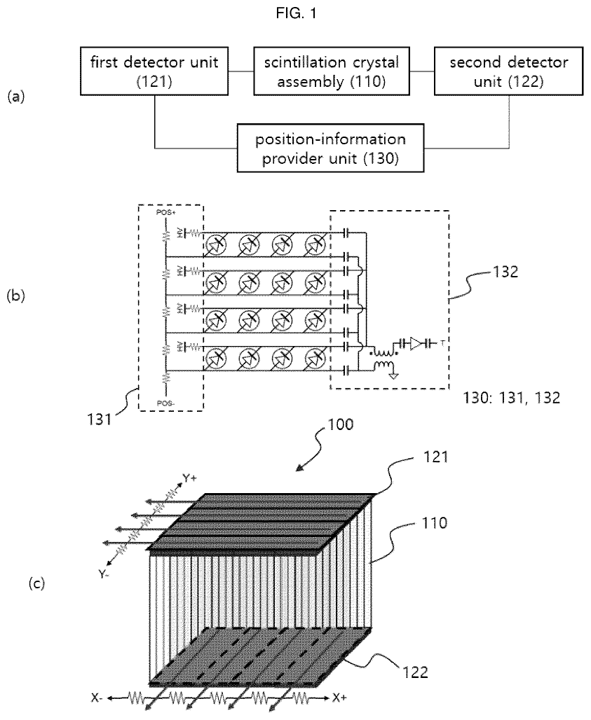

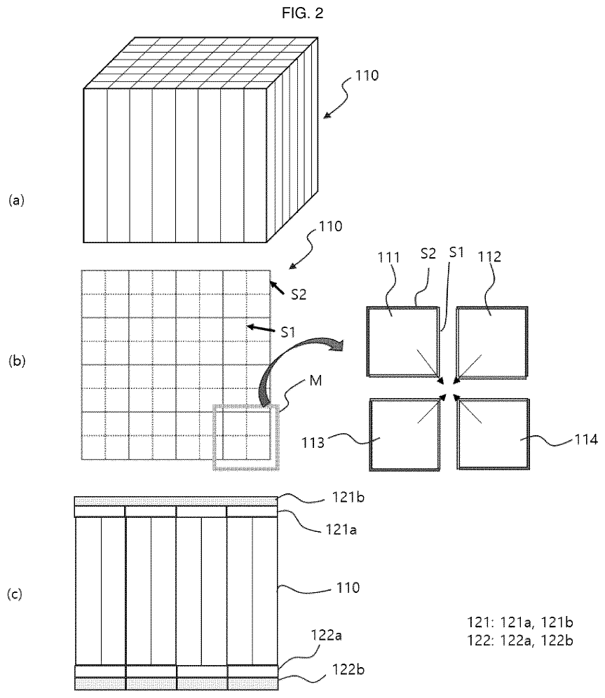

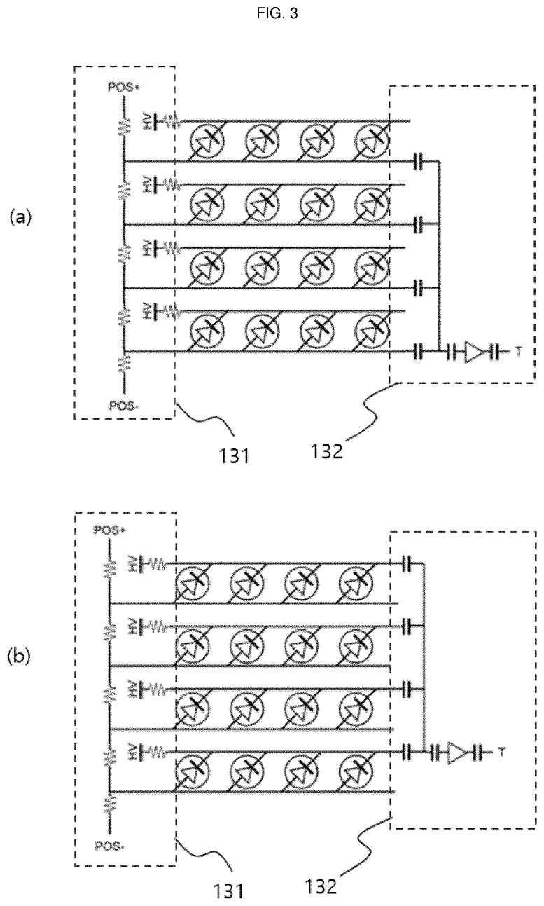

FIG. 1 is a diagram schematically illustrating a signal detection device according to an embodiment of the present invention, FIG. 2 is a perspective view and a top view of a scintillation crystal assembly constituting the signal detection device according to an embodiment of the present invention, and FIG. 3 is a circuit diagram illustrating various embodiments of a position-information provider unit constituting the signal detection device according to an embodiment of the present invention.

Referring to FIGS. 1(a) to 1(c), a signal detection device 100 according to an embodiment of the present invention may include: a scintillation crystal assembly 110 including a plurality of scintillation crystals arranged to form rows and columns and configured to generate and output an optical signal in response to incident radiation; a first detector unit 121 installed at one end of the scintillation crystal assembly 110 and configured to convert the optical signal into an electrical pulse having a magnitude proportional to a signal intensity and to output a first signal, the first detector unit being configured to interconnect scintillation crystals forming columns among the plurality of scintillation crystals; a second detector unit 122 installed at the other end of the scintillation crystal assembly 110 and configured to convert the optical signal into an electrical pulse having a magnitude proportional to the signal intensity and to output a second signal, the second detector unit being configured to interconnect scintillation crystals forming rows among the plurality of scintillation crystals; and a position-information provider unit 130 connected to the first detector unit 121 and the second detector unit 122 and configured to generate and output position information corresponding to a location of a scintillation crystal that has detected the gamma radiation by using the first signal and the second signal.

The scintillation crystal assembly 110 may include a plurality of scintillation crystals 111 and 112 arranged to be in contact with one another. Each of the scintillation crystals 111 and 112 may be provided in a prismatic shape having a top surface, a bottom surface, and side surfaces connecting the top surface and the bottom surface. For example, each scintillation crystal 111 and 112 may have a rectangular prism shape including a top surface, a bottom surface, and four side surfaces. In this case, the top surface and the bottom surface of each scintillation crystal 111 and 112 may be polished surfaces, and the side surfaces may be polished surfaces or unpolished surfaces. The scintillation crystals 111 and 112 may be formed of one selected from LSO, BGO, LYSO, LaBr₃, NaI, and LGSO. For example, the scintillation crystals 111 and 112 may be formed of rectangular-prism-shaped BGO. The scintillation crystal assembly 110 may include 64 scintillation crystals 111 and 112 arranged to form eight columns and eight rows (8×8).

Each scintillation crystal 111 and 112 may be configured to generate and output an optical signal in response to incident radiation and may include at least one unpolished first surface S1. The scintillation crystals 111 and 112 may be arranged in a plurality of rows and a plurality of columns, and scintillation crystals facing each other may be arranged such that their first surfaces S1 are in contact with each other.

In addition, each scintillation crystal 111 and 112 may include an unpolished first surface S1 and a polished second surface S2 connected to the first surface S1. Scintillation crystals facing each other may be arranged such that their first surfaces S1 are in contact with each other and their second surfaces S2 are in contact with each other. In this case, scintillation crystals arranged such that their first surfaces S1 are in contact with each other may form a scintillation crystal unit M, and a plurality of scintillation crystal units M may be arranged to form rows and columns. Scintillation crystal units facing each other may be arranged such that their second surfaces S2 are in contact with each other. In this case, a reflector, such as an enhanced specular reflector (ESR), may be attached between the scintillation crystals 111 and 112 using an optical adhesive. However, when a diffuse reflector such as barium sulfate or Toray film is used, or when no adhesive is applied (for example, when an air gap is present), surfaces of the scintillation crystals may exhibit different reflective characteristics. In general, a diffuse reflector reflects light uniformly in all directions and thus may provide improved DOI resolution even in polished scintillation crystals.

The first detector unit 121 may include a plurality of first photosensors 121a installed at one end of the scintillation crystal assembly 110, and a plurality of first wirings 121b configured to interconnect the first photosensors 121a so as to form a plurality of columns. In this case, the first photosensors 121a may be implemented as SiPMs, and the first wirings 121b may be formed in a strip shape.

The second detector unit 122 may include a plurality of second photosensors 122a installed at the other end of the scintillation crystal assembly 110, and a plurality of second wirings 122b configured to interconnect the second photosensors 122a so as to form a plurality of rows. In this case, the first wirings 121b and the second wirings 122b may be arranged to be orthogonal to each other. Further, the second photosensors 122a may be implemented as SiPMs, and the second wirings 122b may be formed in a strip shape.

The first photosensors 121a and the second photosensors 122a may be arranged to cover the scintillation crystal unit M and to face each other. That is, the first photosensors 121a and the second photosensors 122a may be arranged to respectively cover an upper surface and a lower surface of the scintillation crystal unit M. For example, sixteen scintillation crystal units M may be arranged to form four columns and four rows (4×4), four first wirings 121b may respectively connect four scintillation crystal units M, and four second wirings 122b may respectively connect four scintillation crystal units M.

The position-information provider unit 130 is connected to the first wirings 121b and the second wirings 122b, and may calculate an interaction position or a depth of interaction (DOI) at which scintillation occurs, based on electrical signals output from the first photosensors 121a and the second photosensors 122a.

As illustrated in FIG. 1(b), the position-information provider unit 130 may include a first position-information generator 131 connected to one end of the plurality of first wirings 121b and configured to generate position information corresponding to a position at which scintillation occurs in a scintillation crystal 111, and a first timing-signal generator 132 connected to the other end of the plurality of first wirings 121b and configured to generate timing information. In addition, the position-information provider unit 130 may include a second position-information generator (not shown) connected to one end of the plurality of second wirings 122b and configured to generate position information corresponding to a position at which scintillation occurs in a scintillation crystal 112, and a second timing-signal generator (not shown) connected to the other end of the plurality of second wirings 122b and configured to generate timing information.

The first position-information generator 131 may include wirings (not shown) interconnecting the first photosensors 121a, or wirings interconnecting the first photosensors 121a together with passive elements such as resistors and capacitors. Similarly, the second position-information generator may include wirings (not shown) interconnecting the second photosensors 122a, or wirings interconnecting the second photosensors 122a together with passive elements such as resistors and capacitors.

The first timing-signal generator 132 may include wirings (not shown) interconnecting the first photosensors 121a, or wirings interconnecting the first photosensors 121a together with passive elements such as capacitors and an amplifier. Similarly, the second timing-signal generator may include wirings (not shown) interconnecting the second photosensors 122a, or wirings interconnecting the second photosensors 122a together with passive elements such as capacitors and an amplifier.

Meanwhile, each of the first photosensors 121a and the second photosensors 122a may include a cathode and an anode, and each of the first wirings 121b and the second wirings 122b may include a cathode line interconnecting cathodes of the photosensors and an anode line interconnecting anodes of the photosensors.

The first timing-signal generator 132 and the second timing-signal generator may be configured, as illustrated in FIG. 1(b), such that both the cathode line and the anode line are connected to the amplifier. In this case, a magnitude of a signal input to the amplifier is increased, thereby improving signal quality and providing an advantage of improving timing resolution.

Alternatively, the first timing-signal generator 132 and the second timing-signal generator may be configured, as illustrated in FIG. 3(a), such that opposite ends of the cathode lines are interconnected and connected to the amplifier while the anode lines are left in a floating state, or as illustrated in FIG. 3(b), such that opposite ends of the anode lines are interconnected and connected to the amplifier while the cathode lines are left in a floating state. In this case, compared to the configuration illustrated in FIG. 1(b), the number of components used, such as passive elements, may be reduced, thereby providing an advantage of reducing manufacturing cost.

Although it has been described herein that a plurality of first photosensors 121a are interconnected and connected to the first timing-signal generator 132, and a plurality of second photosensors 122a are interconnected and connected to the second timing-signal generator, the plurality of first photosensors 121a may alternatively be individually connected to the first timing-signal generator 132, and the plurality of second photosensors 122a may alternatively be individually connected to the second timing-signal generator. In addition, the first timing-signal generator 132 and the second timing-signal generator may be configured in various other manners.

A signal detection method according to an embodiment of the present invention may detect a signal by using the above-described signal detection device. According to the signal detection method of the embodiment of the present invention, when an optical signal is generated in response to incident gamma rays, a first signal output in a column direction formed by the plurality of scintillation crystals is detected by detecting the optical signal at one end of the scintillation crystal assembly, and a second signal output in a row direction formed by the plurality of scintillation crystals is detected by detecting the optical signal at the other end of the scintillation crystal assembly, thereby generating position information indicating a location at which the optical signal is generated.

Hereinafter, an example in which signal detection performance is experimentally evaluated using the signal detection device according to an embodiment of the present invention will be described.

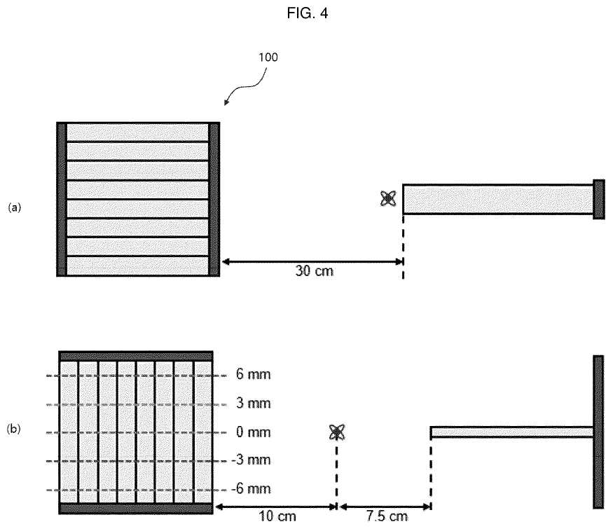

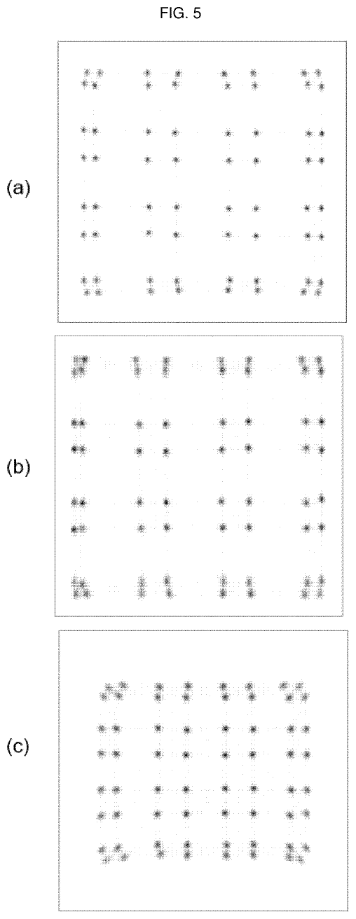

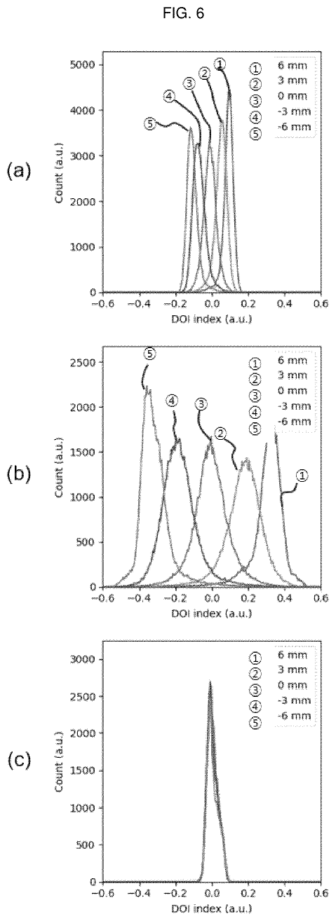

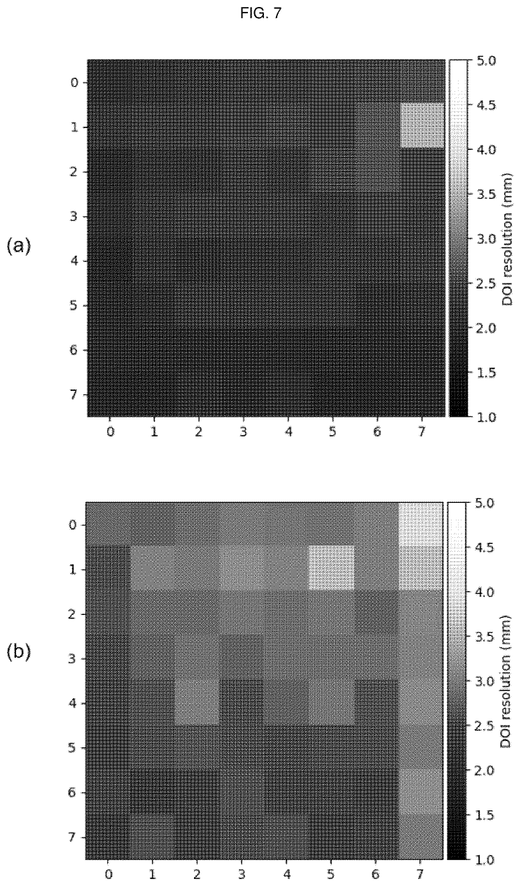

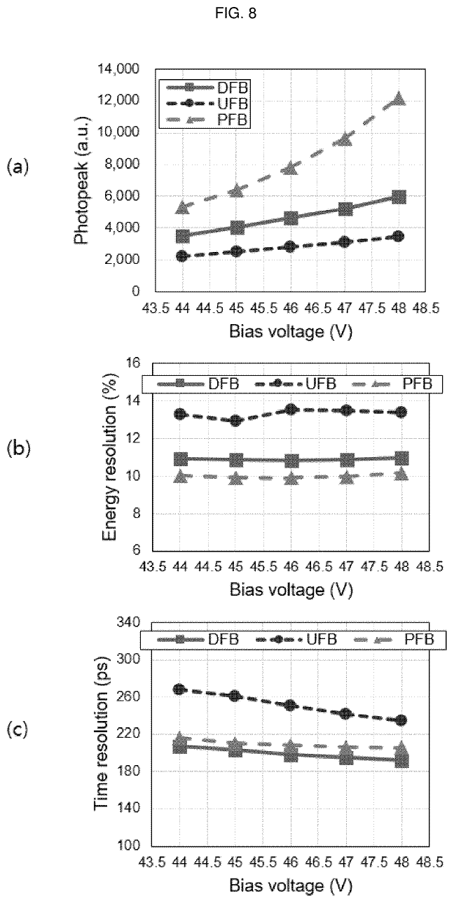

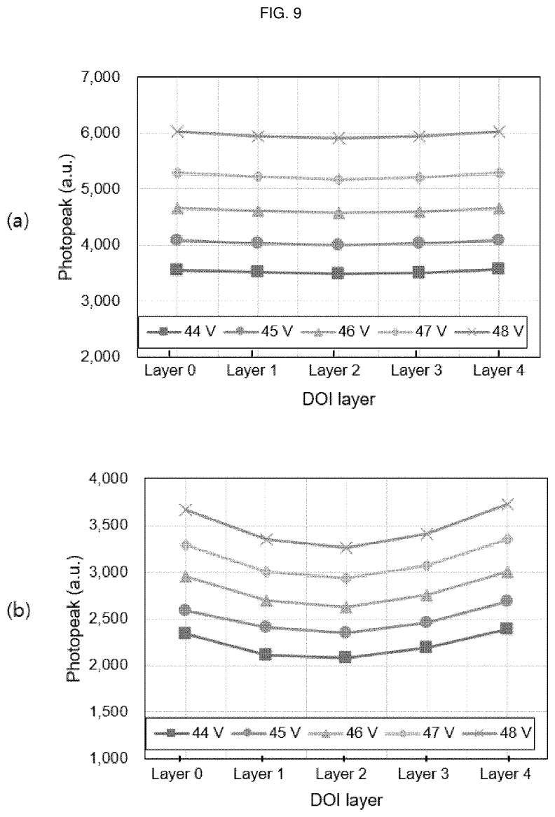

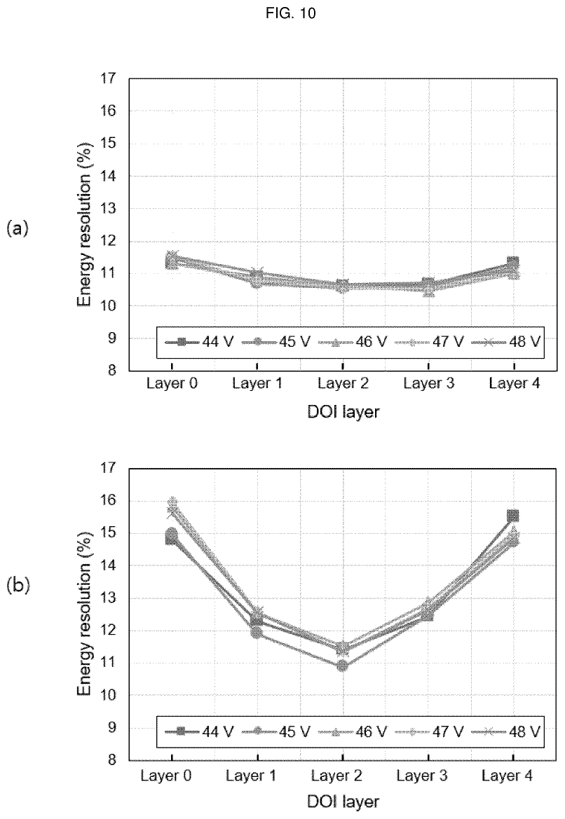

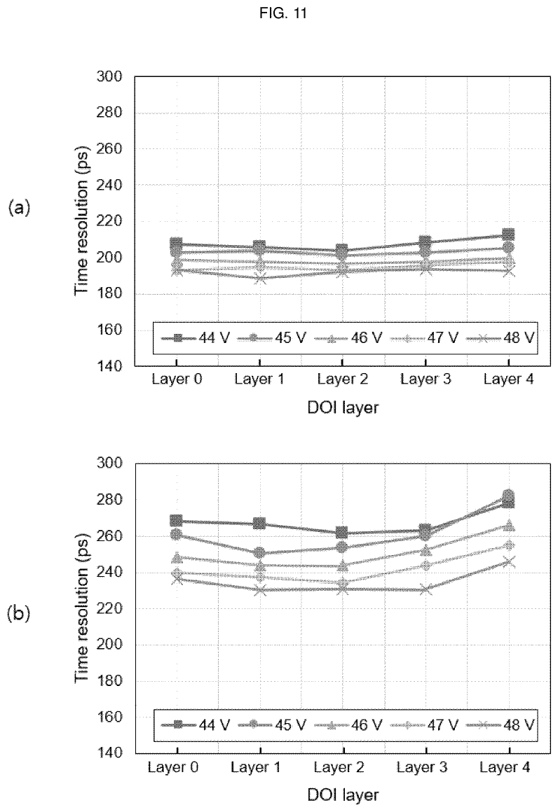

FIG. 4 is a diagram for explaining experimental conditions using the signal detection device according to an embodiment of the present invention, FIG. 5 is a flood map obtained from an experiment performed using the signal detection device according to an embodiment of the present invention, FIG. 6 is a DOI index histogram obtained from an experiment performed using the signal detection device according to an embodiment of the present invention, FIG. 7 is a DOI resolution map obtained from an experiment performed using the signal detection device according to an embodiment of the present invention, FIG. 8 is a graph illustrating variations in detection performance according to bias voltage and a surface finishing method of scintillation crystals, FIG. 9 is a graph illustrating a photopeak position according to DOI layers and bias voltage, FIG. 10 is a graph illustrating energy resolution according to DOI layers and bias voltage, and FIG. 11 is a graph illustrating timing resolution according to DOI layers and bias voltage.

### EXAMPLES

### 1. Materials and Methods

### 1.1 Dual-End Detection Device

In order to develop a high-resolution time-of-flight (TOF) detection device for brain imaging applications, a dual-end detection device was constructed using an 8×8 scintillation crystal array having a 2 mm pitch and a length of 15 mm. The scintillation crystal array was matched with a 4×4 SiPM array (photosensors) having a pixel pitch of 4 mm (AFBR-S4N44P164M, Broadcom Inc., San Jose, CA, USA), such that one scintillation crystal unit composed of four scintillation crystals was aligned with one SiPM. To ensure efficient optical transmission, a 0.5 mm optical guide (not shown) was inserted between the scintillation crystals and the SiPMs.

To achieve efficient signal compression, a 1×4 pixel group of the 4×4 SiPM array was combined by wiring to form a strip pixel having a size of 4 mm×16 mm. This strip pixel was multiplexed using a one-dimensional charge division circuit, thereby allowing a one-dimensional interaction position to be determined using two position signals (see FIG. 1(c)). This SiPM circuit was attached to an upper surface of the scintillation crystals (first detector unit 121) to determine an interaction position in a Y direction, and was rotated by 90° and attached to a lower surface of the scintillation crystals (second detector unit 122) to determine an interaction position in an X direction (see FIG. 1(c)). Using this configuration, a two-dimensional interaction depth or interaction position within the scintillation crystal can be calculated using four position signals from the upper side (Y+ and Y−) and the lower side (X+ and X−), as expressed in Equations 1 and 2 below.

$$X = \frac{{X}^{+} - {X}^{-}}{{X}^{+} + {X}^{-}} \qquad [ Equation 1 ]$$

$$Y = \frac{{Y}^{+} - {Y}^{-}}{{Y}^{+} + {Y}^{-}} \qquad [ Equation 2 ]$$

Energy is calculated by summing all position signals from both an upper surface and a lower surface of the scintillation crystal, as expressed in Equation 3 below.

$$E = {X}^{+} + {X}^{-} + {Y}^{+} + {Y}^{-} \qquad [ Equation 3 ]$$

A DOI index used to determine an interaction depth may be calculated using a ratio of sensor signals from the upper surface and the lower surface, as expressed in Equation 4 below.

$$DOI = \frac{{Y}^{+} + {Y}^{-} - {X}^{+} - {X}^{-}}{{X}^{+} + {X}^{-} + {Y}^{+} + {Y}^{-}} \qquad [ Equation 4 ]$$

In order to improve timing resolution, high-speed timing signals are generated from SiPM arrays disposed on the upper surface and the lower surface. Signals from four strip pixels are combined using a high-pass filter and then amplified through a high-frequency amplifier (see FIG. 1(b)).

A timestamp may be determined by averaging signals respectively output from sensors disposed on the upper surface and the lower surface of the scintillation crystal, as expressed in Equation 5 below.

$$DOI = {( \frac{{T}_{T} + {T}_{B}}{2} )}^{\text{?}} \qquad [ Equation 5 ]$$

### 1.2 Configuration of Scintillation Crystal Array (Scintillation Crystal Assembly)

In order to compare with a conventional method in which all side surfaces of scintillation crystals are processed in the same manner, three scintillation crystals having identical dimensions were prepared. The three scintillation crystals were configured as a dual-finishing block (DFB) in which two side surfaces are polished and two side surfaces are unpolished, an unpolished-finishing block (UFB) in which all side surfaces are unpolished, and a polished-finishing block (PFB) in which all side surfaces are polished.

The dual-finishing block is illustrated in FIG. 2(b), and includes a polished surface (S1) and an unpolished surface (S2). As illustrated in FIG. 2(c), four dual-finishing blocks, for example scintillation crystals (111, 112), are matched to a single SiPM pixel (first photosensor 121a, second photosensor 122a). By using this configuration, the unpolished surfaces (S2) may be disposed at all edge regions of the SiPM pixel. Arranging unpolished surfaces at pixel edge regions was not considered, because a significant amount of light may escape from scintillation crystals located at the edges, thereby degrading performance.

In the comparative groups, the unpolished-finishing block (UFB) and the polished-finishing block (PFB) were configured such that all surfaces were treated with unpolished finishing and polished finishing, respectively. In all scintillation crystals, upper and lower surfaces, that is, surfaces in contact with SiPM pixels, were polished. All scintillation crystals or blocks were fabricated using LGSO crystals from the same production lot. In all blocks, an Enhanced Specular Reflector (ESR) was bonded between polished surfaces (S1) and between unpolished surfaces (S2) of the scintillation crystals, thereby clearly separating pixels. Configurations of the three blocks are summarized in Table 1.

TABLE 1

| Scintillation Crystal | | |
|---|---|---|
| (block name) | S1 | S2 |
| DFB | Unpolished | Polished |
| UFB | Unpolished | Unpolished |
| PFB | Polished | Polished |

Using the three scintillation crystals or blocks described above, scintillation crystal units were fabricated, and a scintillation crystal assembly was fabricated using the scintillation crystal units. In addition, a first detector unit and a second detector unit were respectively coupled to an upper surface and a lower surface of the scintillation crystal assembly, and a position-information provider unit was connected to the first detector unit and the second detector unit, thereby fabricating a signal detection device.

### 1.3 Experimental Setup

Two different experimental setups were employed to measure performance of the signal detection device.

In order to obtain a uniform flood map, energy resolution, and timing resolution, a front-irradiation setup in which gamma rays were irradiated onto a front surface of the scintillation crystal assembly was adopted, as illustrated in FIG. 4(a). For the front-irradiation experiment, a single-pixel SiPM signal detection device including a 3×3×20 mm³ LYSO crystal and a single 4 mm SiPM (AFBR-S4N44C013, Broadcom Inc., USA) was used as a reference signal detection device. A single timing resolution of the reference signal detection device was 127.06 ps.

In order to measure DOI resolution, a side-irradiation setup in which gamma rays were irradiated onto a side surface of the scintillation crystal assembly was adopted, as illustrated in FIG. 4(b). In this case, gamma rays incident on a specific depth of the scintillation crystal assembly could be selectively filtered, thereby enabling accurate DOI resolution measurement. In this experimental setup, a reference signal detection device was configured by coupling a scintillation crystal having dimensions of 16×0.75×17 mm³ with a 4×4 SiPM array (AFBR-S4N44P164M), in order to avoid shadow regions during coincidence acquisition.

Position signals and timing signals of the dual-end signal detection device and the reference signal detection device were digitized using an FPGA-based DAQ system (BASP-10011, Brightonix Imaging Inc., Seoul, Republic of Korea). The DAQ system employed an 80 MHz, 12-bit ADC for energy calculation, and a tapped delay line time-to-digital converter (TDC) implemented in the FPGA for precise timing measurement. The TDC included real-time bin width calibration and had an intrinsic timing resolution of 55.6 ps FWHM. In all experiments for timestamp pickoff, a leading-edge discriminator with a threshold voltage of 20 mV was used. Coincidence signals were discriminated within the BASP-10011 board using a coincidence window of 12.5 ns.

### 1.4 Data Acquisition and Analysis

In the side-irradiation experiment, data were acquired at positions of −6, −3, 0, 3, and 6 mm from a center of the scintillation crystal, thereby obtaining DOI index distributions of each scintillation crystal at various depths (see FIG. 4(b)). By analyzing a relationship between a center value of the DOI index distribution and an actual irradiation depth, the DOI index was converted into millimeters, and DOI resolution was determined by calculating a full width at half maximum (FWHM) of the DOI index distribution at each interaction depth.

Energy resolution and timing resolution were calculated from data obtained through the front-irradiation experiment. When DOI could be discriminated, interaction depths were divided into five layers: −7.5 to −4.5 mm (DOI layer 0), −4.5 to −1.5 mm (DOI layer 1), −1.5 to 1.5 mm (DOI layer 2), 1.5 to 4.5 mm (DOI layer 3), and 4.5 to 7.5 mm (DOI layer 4). Energy resolution and timing resolution were calculated for each DOI layer, and an average value across the five layers was defined as an energy resolution and a timing resolution of each block.

In order to evaluate performance as a function of SiPM bias voltage, a bias voltage of the dual-end signal detection device was increased from 44.0 V to 48.0 V in increments of 1.0 V, and data were acquired at each voltage level. In all cases, timing resolution and DOI resolution analyses were performed using only events within an energy window defined as a full width at tenth maximum (FWTM) measured at one-tenth of a peak height of an energy spectrum.

### 2. Results

### 2.1 Flood Map Quality

FIG. 5 shows flood maps of the signal detection device according to each scintillation crystal assembly configuration obtained in the front-irradiation experiment. Specifically, FIG. 5(a) shows a flood map of the signal detection device fabricated using a dual-finishing block (DFB), FIG. 5(b) shows a flood map fabricated using an unpolished-finishing block (UFB), and FIG. 5(c) shows a flood map fabricated using a polished-finishing block (PFB).

Referring to FIGS. 5(a) to 5(c), in all cases, 64 scintillation crystals were clearly distinguished. A size of the flood map (i.e., a dynamic range) increased in an order of UFB, DFB, and PFB as unpolished scintillation crystals were applied. However, in the UFB configuration, spacing between scintillation crystals located at edges was narrower than in other configurations. In contrast, the PFB configuration exhibited more uniform spacing between pixels in the flood map. The DFB configuration exhibited intermediate characteristics between the UFB and PFB configurations and was confirmed to have overall best flood map quality.

### 2.2 DOI Resolution

DOI resolution was determined from the side-irradiation experiment. FIG. 6 shows histograms of DOI indices acquired at −6 mm, −3 mm, 0 mm, 3 mm, and 6 mm for each block. Specifically, FIG. 6(a) shows a histogram obtained from the signal detection device fabricated using the DFB, FIG. 6(b) shows a histogram obtained using the UFB, and FIG. 6(c) shows a histogram obtained using the PFB.

Referring first to FIG. 6(c), in the PFB configuration, no noticeable spread was observed in the DOI histogram, and thus an interaction depth could not be measured. In contrast, as shown in FIG. 6(b), the UFB configuration exhibited the largest spread in the DOI index. The DFB configuration, as shown in FIG. 6(a), exhibited a smaller spread compared to the UFB configuration. An average DOI resolution across 64 scintillation crystals was measured as 2.21±0.26 mm for the UFB configuration (FIG. 7(a)) and 2.80±0.30 mm for the DFB configuration (FIG. 7(b)).

### 2.3 Energy Peak Position, Energy Resolution, and Timing Resolution

FIG. 8 shows results of detection performance measurements at various bias voltages. Results of the UFB and DFB configurations, excluding the PFB configuration for which DOI could not be measured, represent average values considering DOI correction, since DOI analysis was performed by dividing data into five segments.

FIG. 8(a) shows a photopeak position as a function of bias voltage for each block configuration. The photopeak exhibited significant differences depending on surface finishing conditions. In the UFB and DFB configurations, significant light loss due to light scattering at side surfaces was observed compared to the PFB configuration. As the SiPM bias voltage increased, the photopeak tended to increase due to increases in photon detection efficiency and gain.

Despite an increase in bias voltage, energy resolution remained nearly constant. Referring to FIG. 8(b), the PFB configuration, which exhibited the highest photopeak, showed the best energy resolution. At a bias voltage of 48 V, average energy resolution was measured as 10.99±1.05% for the DFB configuration, 13.39±1.58% for the UFB configuration, and 10.19±0.55% for the PFB configuration. The particularly low energy resolution in the UFB configuration is likely due to increased uncertainty caused by variation in photopeak position according to DOI and photon loss.

Referring to FIG. 8(c), timing resolution improved in all block configurations as bias voltage increased, which is attributed to an increase in photon detection efficiency (PDE). A mean time method mitigated time-walk effects by averaging timestamps measured at upper and lower surfaces, while minimizing time-walk effects by calculating timing resolution for each DOI segment. Despite these efforts, the UFB configuration, which exhibited the best DOI resolution, showed the worst timing resolution. This indicates that degradation of timing resolution due to light loss in the UFB configuration outweighed benefits of time-walk correction. In contrast, the DFB configuration exhibited better timing resolution than the PFB configuration. At a bias voltage of 48 V, timing resolution was measured as 192.0±12.8 ps for the DFB configuration, 234.8±17.9 ps for the UFB configuration, and 206.3±9.4 ps for the PFB configuration.

### 2.4 Performance Dependence on DOI

An analysis of performance variation according to DOI was performed for the UFB and DFB configurations, and results as shown in FIG. 9 were obtained. Referring to FIG. 9(b), in the UFB configuration, a 511 keV photopeak at a center of the scintillation crystal assembly (DOI layer 2) was more than 10% lower than those in outer regions (DOI layers 0 and 4). In contrast, in the DFB configuration, as shown in FIG. 9(a), a difference in photopeak values between outer and central regions was less than 2%, indicating relatively uniform performance regardless of depth.

FIG. 10 shows differences in energy resolution according to depth. In both the UFB configuration (FIG. 10(b)) and the DFB configuration (FIG. 10(a)), energy resolution decreased in outer regions of the scintillation crystal assembly where photopeak positions were higher. However, the DFB configuration exhibited less than an 8% difference in energy resolution, whereas the UFB configuration exhibited a difference of more than 35%. This phenomenon is likely due to larger variation in the number of photons reaching a photosensor because light must undergo multiple reflections to reach a photosensor disposed at an opposite end of the scintillation crystal assembly when gamma rays interact at one end.

FIG. 11 is a graph showing variation in timing resolution according to position.

FIG. 11(a) shows timing resolution of the DFB configuration, and FIG. 11(b) shows timing resolution of the UFB configuration. Since the mean time method was used for timestamp calculation, timing resolution of the UFB and DFB configurations exhibited minimal variation with depth.

### 3. Discussion

As described above, performance of a dual-end signal detection device for use in a brain-dedicated PET system was developed and evaluated. Instead of a conventionally used unpolished-finishing block (UFB) configuration that is generally employed in a dual-end signal detection device, a dual-finishing block (DFB) configuration having both polished surfaces and unpolished surfaces was adopted to optimize timing resolution. Although this approach resulted in a slight decrease in energy resolution compared to a polished-finishing block (PFB) configuration in which all surfaces are polished, good energy resolution within a range of 10% was still achieved. In addition, DOI performance was slightly degraded from 2.2 mm to 2.8 mm compared to the UFB configuration; however, a DOI resolution of less than 3 mm is sufficient to compensate for degradation of spatial resolution caused by parallax error in a brain-dedicated PET system.

The DFB configuration exhibited more uniform performance across various DOI layers and was able to collect a greater number of photons compared to the UFB configuration. As a result, limitations of the UFB configuration were overcome, and improved energy measurement performance and timing resolution were achieved.

Furthermore, although an amount of light reaching a photosensor in the DFB configuration was reduced compared to the PFB configuration, timing resolution was improved. This suggests that, despite reduced light intensity, a sufficient number of initial photons reached photosensors at both ends in the DFB configuration. In addition, an ability to measure DOI in the DFB configuration may be considered a major factor contributing to improvement of timing resolution.

### 4. Conclusion

According to an embodiment of the present invention, although energy resolution was slightly reduced compared to a polished-finishing method and DOI resolution was slightly reduced compared to an unpolished-finishing method, the best timing resolution performance was achieved. By optimizing performance of a dual-end signal detection device using the present invention, a TOF/DOI PET system with excellent image quality may be developed.

In addition, as blue-light detection efficiency of SiPMs has recently improved, there have been many attempts to use Bismuth Germanate (BGO) scintillation crystals as TOF detectors. One study has shown that dual-end readout can increase detection efficiency of Cherenkov light in BGO scintillation crystals. Another study has shown that timing resolution can be further improved by correcting time uncertainty within a scintillation crystal using DOI information. However, such studies compared performance between a PFB configuration and a UFB configuration. Accordingly, by applying the DFB configuration proposed in the present invention, timing resolution of a BGO detector may be further improved.

The present invention has been described with reference to the accompanying drawings and the foregoing preferred embodiments; however, the present invention is not limited thereto and is defined by the claims that follow. Accordingly, a person having ordinary skill in the art may make various modifications and changes to the present invention without departing from the technical spirit defined in the following claims.

### REFERENCE NUMERALS

100: signal detection device
110: scintillation crystal assembly
111, 112: scintillation crystal
121: first detector unit
122: second detector unit
130: position-information provider unit
M: scintillation crystal unit

1. A signal detection module, comprising:
scintillation crystals configured to generate and output optical signals in response to incident radiation, each scintillation crystal having at least one unpolished first surface,
wherein the scintillation crystals are arranged in a plurality of rows and a plurality of columns, and
wherein scintillation crystals facing each other are arranged such that the first surfaces thereof are in contact with each other.

2. The signal detection module of claim 1,
wherein each scintillation crystal includes a polished second surface connected to the first surface,
wherein scintillation crystals arranged with the first surfaces in contact with each other constitute a scintillation crystal unit, and
wherein the second surface is arranged to surround at least a portion of the scintillation crystal unit.

3. The signal detection module of claim 2,
wherein the scintillation crystals constituting the scintillation crystal unit are arranged to form two or more rows and two or more columns.

4. The signal detection module of claim 2,
wherein a plurality of scintillation crystal units are arranged in rows and columns, and
wherein scintillation crystal units facing each other are arranged such that the second surfaces thereof are in contact with each other.

5. The signal detection module of claim 1,
wherein each scintillation crystal has a prismatic shape including a top surface, a bottom surface, and a plurality of side surfaces, and
wherein at least one of the plurality of side surfaces includes the first surface.
